(19) United States
(12) Patent Application Publication
(10) Pub. No.: US 2010/0303276 A1
(43) Pub. Date: Dec. 2, 2010

(54) LOUDSPEAKER SURROUND MOUNT

(75) Inventor: Drew Kallen, Chandler, AZ (US)

Correspondence Address: STEPTOE & JOHNSON LLP, 2121 AVENUE OF THE STARS, SUITE 2800, LOS ANGELES, CA, 90067, US

(73) Assignee: Rockford Corporation, Tempe, AZ (US)

(21) Appl. No.: 12/474,512

(22) Filed: May 29, 2009

(51) Int. Cl. H04R 1/02

(52) U.S. Cl. 381/386

(57) ABSTRACT

A loudspeaker configured to include a suspension system which maximizes performance. Materials of the suspension system are selected for ease and effectiveness of manufacturing.

### BACKGROUND

The present disclosure relates generally to loudspeakers and in particular, to an approach to mounting a loudspeaker surround.

A loudspeaker or speaker system can be characterized as an electroacoustical transducer that converts an electrical signal to sound. Moreover, the term loudspeaker can refer to individual transducers or drivers or to complete systems consisting of an enclosure incorporating one or more drivers and electrical filter components. As with other electroacoustic transducers, loudspeakers can be the most variable element in an audio system and can be responsible for a significant degree of audible variation between sound systems.

In order to reproduce a wide range of frequencies, loudspeaker systems can include more than one driver, in particular for a high sound pressure level or for high accuracy. Individual drivers can be used to reproduce different frequency ranges. Drivers with very low frequencies are referred to as subwoofers, those with low frequencies are called woofers and mid-range speakers are those with middle range frequencies. Also, tweeters are drivers with high frequencies and supertweeters can be optimized for the highest audible frequencies.

One of the most common type of driver employs a cone-like diaphragm connected to a rigid frame, via a flexible suspension that constrains a coil of fine wire to move axially through a cylindrical magnetic gap. When an electrical signal is applied to the coil, a magnetic field is created by the electric current in the coil which thus becomes an electromagnet field. The coil and the driver's magnetic system interact, generating a mechanical force which causes the coil and the attached cone to move back and forth, to thereby reproduce sound under the control of the applied electrical signal coming the from an amplifier.

It has been found that the frame of a speaker system should be designed for rigidity to avoid deformation, which will change the concentric alignment of the moving coil in the magnetic gap and thus magnetic conditions in the magnet gap, and could even cause the coil to rub against the walls of the magnetic gap. Frames are typically cast or formed from stamped metal, although molded plastic frames are becoming common, especially for inexpensive drivers.

The suspension system of a speaker system maintains the coil centered in the magnetic gap and provides a restoring force to make the speaker cone return to a neutral position after moving. A typical suspension system consists of two parts, namely, the spider and the surround. The spider connects the diaphragm or coil to the frame and provides the majority of the restoring force. The surround facilitates the stability of the coil and cone assembly as well as allows translational motion aligned with the magnetic gap. The spider is usually made of corrugated fabric disk, generally with a coating of a material intended to improve mechanical properties. The surround can be a roll of rubber or foam, or a ring of corrugated fabric (often coated), attached to the outer circumference of the cone and to the frame.

It has been observed that the area of a cone is a factor having a significant bearing on the efficiency of a speaker system. The volume of air that a loudspeaker can displace is dependent upon the area of the cone as well as the range of motion permitted by the suspension system.

Since the dimension of a loudspeaker is often predetermined or constrained by design parameters, the area of the cone of each loudspeaker can be also thereby limited. Thus, in certain circumstances, the efficiency of a speaker can not be improved by changing the overall dimensions of the frame of a speaker system.

Additionally, the performance of a loudspeaker has been found to be directly related to the characteristic behavior of a suspension system. Further, approaches to manufacturing components of a suspension system can have a significant bearing on the feasibility of a suspension design.

Conventional approaches to surround to frame connections generally rely on one surround surface bonded to a single surface of the frame. Such bonding surface are often perpendicular to the motion of the surround created by the moving coil and magnet system. This perpendicular motion results in forces being applied to the surround landing bonding area tending to separate the surround from the frame.

The connection of the surround to the cone traditionally involves a single surface attachment, one which is also generally perpendicular to the motion of these components. As such, the surround to cone connection can also benefit from an alternative approach seeking to enhance structural integrity.

Accordingly, there is a need for an approach to mounting components of a loudspeaker which maximizes desired loudspeaker characteristic behavior. There is also a need for an effective approach to manufacturing components of a speaker suspension system so that costs can be minimized.

The present disclosure addresses these and other needs.

### SUMMARY OF THE DISCLOSURE

Briefly and in general terms, the present disclosure is directed towards an approach to mounting speaker suspension components. The present disclosure is also generally concerned with approaches to the manufacturing of the suspension components.

In one aspect, a vertical attach approach to mounting a surround of a loudspeaker system is contemplated. In this regard, a periphery of a surround is configured with a vertical mount component having a width greater than remaining portions of the surround. The vertical mount component includes a first part generally defining in cross-section a rectangle, and a second part contiguous with the first part and which defines a right triangle in cross-section. The specific proportional relationships of the rectangle and triangle portions are selected to maximize desired mounting characteristics and to optimize speaker performance gain.

In another aspect, the components of a suspension system are made from materials having inherent elastic characteristics. More specifically, the surround can be formed from elastomeric materials, any and all variants of rubber compounds and other moldable flexible and elastic materials so that the surround can be quickly and conveniently extracted from tooling.

The shape of the surround base landing area that gets bonded to the frame allows for the required adhesive to engage or encapsulate (three) different faces (surfaces) of the surround landing effectively encapsulating this area. In this contemplated approach, the bonding surfaces are in both the perpendicular and parallel orientation to the natural motion of the loudspeaker, thus reducing and distributing the singular common stress mode over two or more bonding surface orientations. The required area for the surround attachment on the frame follows similarly to the shape of the surround landing base. This channel area on the frame is contemplated to be of similar height on the inner most area and can match the height on the outer diameter of the surround where the nominal surround thickness begins for linear suspension contribution. In other approaches, an outer periphery of a vertical wall of the surround can be at or below a height of an outer wall of the channel. To achieve the surround bonding channel on a typical stamped style frame, the approach includes a two piece frame structure that can be molded or cast into shape. To maximize effective cone area (Sd), this second part also serves as the mounting hole securing structure when the two pieces are securely bonded together.

In yet a further aspect, the bonding channel can be equipped with a reservoir for accepting bonding material or adhesives. The reservoir can be formed in any of the sidewalls forming the channel.

Other features of the disclosed system will become apparent from the following detailed description, taken in conjunction with the accompanying drawings, which illustrate, by way of example, the principles of the embodiments.

### BRIEF DESCRIPTION OF THE DRAWINGS

FIG. 1 is a perspective view, depicting one embodiment of a loudspeaker design;

FIG. 2 is a cross-sectional and partially exploded view, depicting the design of FIG. 1 with the surround detached from remaining portions of the loudspeaker;

FIG. 3 is a cross-sectional view, depicting an assembled form of the components of FIG. 2;

FIG. 4 is an enlarged cross-sectional view, depicting mounting structure of a surround;

FIG. 5 is a further enlarged cross-sectional view, depicting further aspects of surround mounting structure;

FIG. 6 is a cross-sectional view, depicting a traditional approach to surround mounting; and

FIG. 7 is a cross-sectional view, depicting a comparison of traditional and presently disclosed approaches to surround mounting.

### DETAILED DESCRIPTION

A loudspeaker's performance is directly related to the characteristic behavior of the suspension system employed by the loudspeaker. The suspension is an integral required component of a loudspeaker and the geometry, materials, and techniques have not significantly changed over the years.

The present disclosure, however, describes a vertical attach approach to mounting a surround into a loudspeaker which provides for performance improvement opportunities. The key to implementing this technology is two-fold. First, the manufacturing tooling and fabrication can require that the surround itself to be extracted from the molding tool rather than be ejected. Accordingly, materials with desirable inherent elastic characteristics are selected so that no significant extra time or tooling is needed to remove the surround component from the tool.

The second key can be provided by a vertical surface area for mounting the surround to the frame and which is in the same annular plane as the outer diameter of the surround roll. In conventional designs the surround mounting is horizontal (perpendicular) to the outer diameter surround roll. The performance gain is evident in the increase in the effective radiating area of the cone/surround assembly by allowing for larger diameter surround for a given mounting diameter. The greater the radiating cone area the greater the acoustic output capability both in nominal sensitivity and maximum output. Also, by encapsulating surround both vertically and horizontally it provides greater hold strength than a conventional flat overlap technique.

The basic method for calculating maximum volume of air displaced by a speakers linear motion can be calculated using the following relationship.

Vd=Sd*Xmax

The formula for determining a speaker's reference efficiency can, in turn, be determined from the following equation.

$$η o = \frac{ρ \cdot B {l}^{2} \cdot {S}_{d}^{2}}{2 \cdot π \cdot c \cdot {M}_{ms}^{2} \cdot {R}_{e} \times 100 \%}$$

Here, Sd is measured in square metres (m²) and represents the effective area of the cone or diaphragm. This value varies with the conformation of the cone, and details of the surround. Moreover, this value is generally accepted as the cone body diameter plus half the width of the annulus (surround). It is to be recognized that wide roll surrounds can have significantly less S_{d} than conventional types.

The term Xmax is specified in millimeters (mm) and in the simplest form, it is calculated by subtracting the height of the voice coil winding from the height of the magnetic gap. The absolute value is then taken and an indicator of a loudspeaker motor's linear range is thereby represented. Although readily determined, it can neglect non-linearities and limitations introduced by the suspension, which can be substantial for some drivers. In a different approach, a combined mechanical/acoustical measure was suggested, in which a driver is progressively driven to high levels at low frequencies, with Xₘₐₓ determined at 10% total harmonic distortion (THD). This method sometimes better represents actual driver performance, but it is harder and more time-consuming to determine.

Next, the volume displaced by the cone or V_{d} (specified in liters (L)), is determined by multiplying the cone area (S_{d}) by Xₘₐₓ. A particular value may be achieved in any of several ways, such as, by having a small cone with a large Xₘₐₓ, or a large cone with a small Xₘₐₓ. Comparing V_{d} values will give an indication of the maximum output of a driver at low frequencies. High Xₘₐₓ, small cone diameter drivers are likely to be inefficient, since much of the voice coil winding will be outside the magnetic gap at any one time and will therefore contribute little or nothing to cone motion. Likewise, large cone diameter, small Xₘₐₓ drivers are likely to be more efficient as they will not need, and so may not have, long voice coils. Improved matching between the driver diaphragm and the air can change the effective value of cone displacement, in which case the T/S models no longer strictly apply.

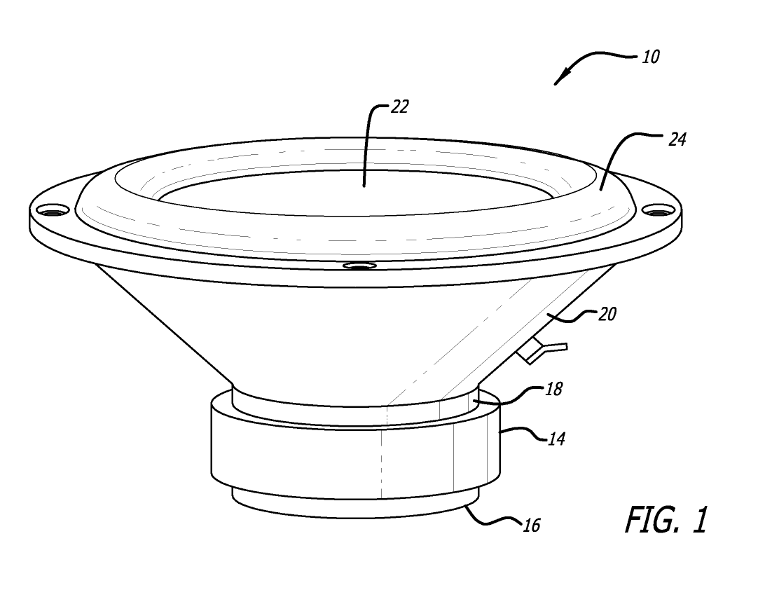

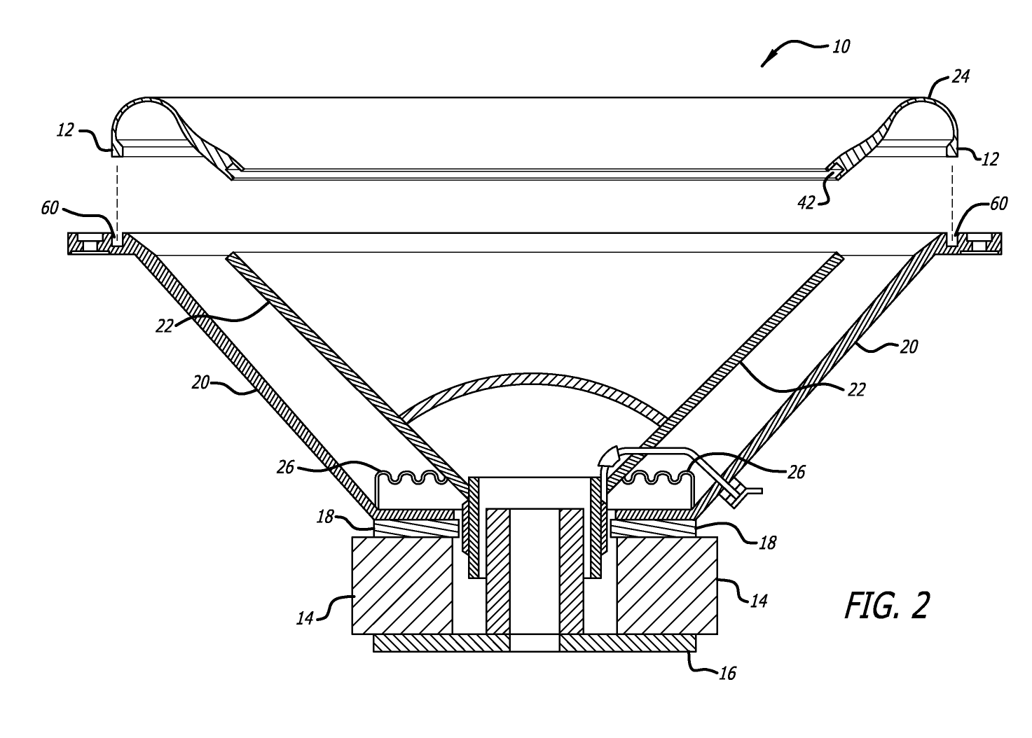

Thus, to optimize speaker performance gain, the surround can be equipped with a vertical attach mount approach which maximizes the effective area of the cone or diaphragm. With reference now to FIGS. 1-4, which are provided by way of example and not limitation there is shown an embodiment of a speaker 10 which embodies a vertical attach mount 12 which facilitates optimization of speaker performance.

In one approach, the speaker assembly can include a magnet 14 mounted between a bottom plate 16 and a top plate 18. Mounted on the top plate 18 is a speaker frame 20. A cone or diaphragm 22 is supported by a surround 24 and a spider assembly 26. The outer diameter or periphery 30 of the surround 24 is mounted to the frame 20 by the vertical attach mount structure 12.

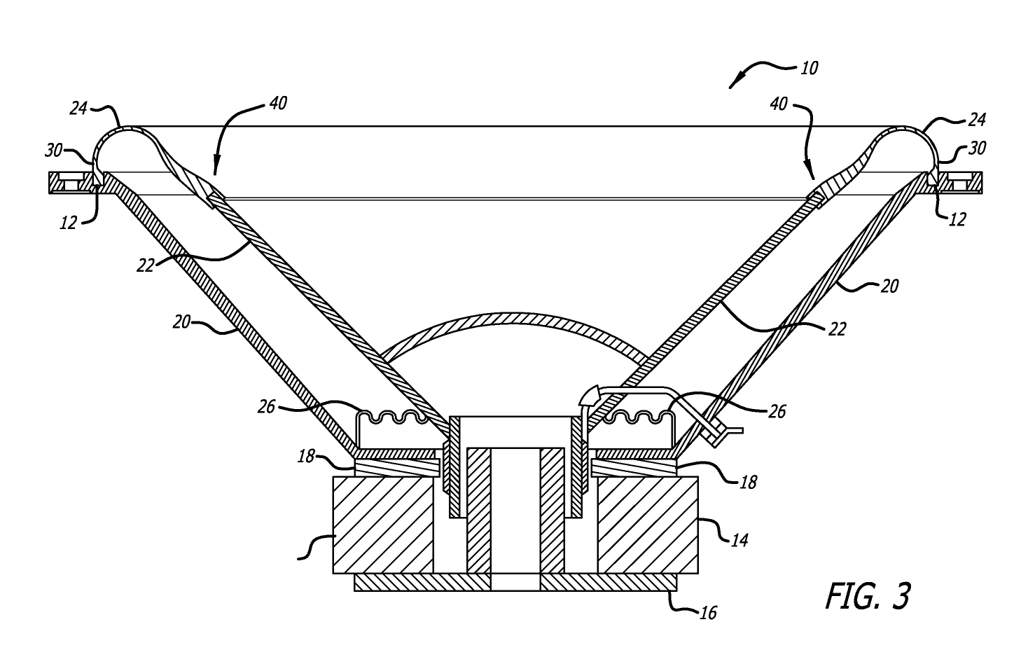

A junction between the surround 24 and the diaphragm 22 can be characterized by a three surface connection 40. A channel 42 is formed in the inner periphery of the diaphragm 22, the channel 42 being sized to securely receive an edge of the diaphragm 24. Conventional bonding materials can be employed to permanently connect these structures (See FIG. 3).

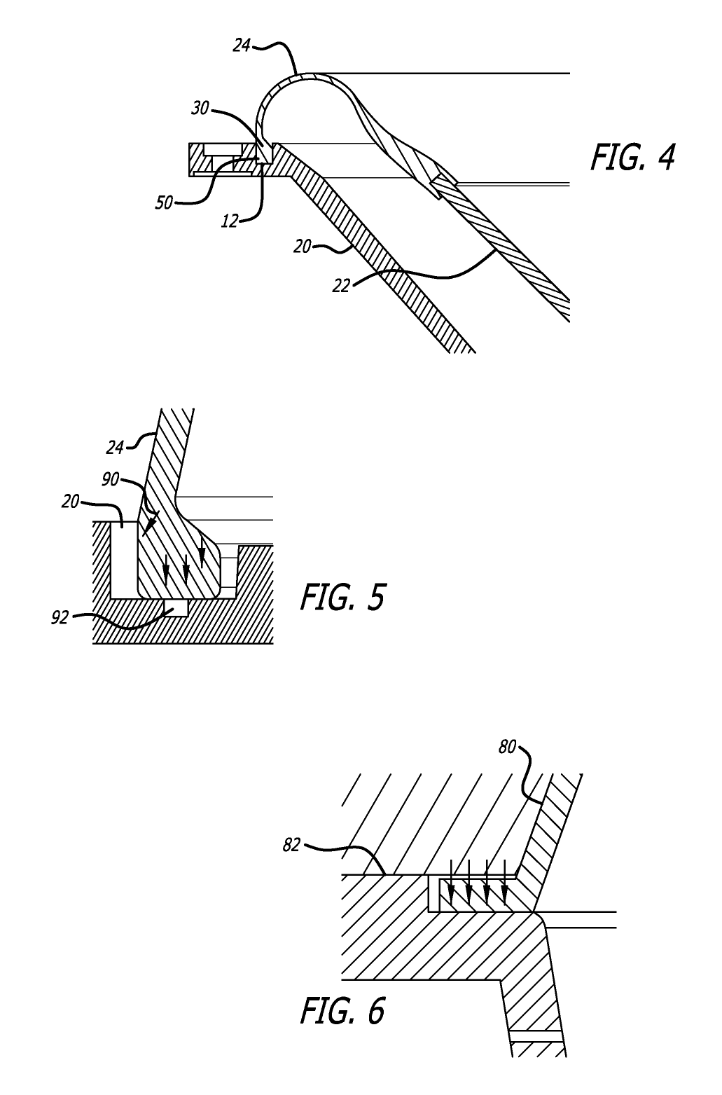

As best seen in FIG. 4, when viewed in cross-section, the vertical mount 12 includes a first generally rectangular portion 50 which is continuous with a second triangular portion 52. In one approach, the rectangular portion 50 has a base which is typically four to five times the nominal thickness of the flexible moving suspension portion of the surround 24. It is further contemplated that the height and channel depth of the rectangular portion of the surround should match the idealized shape of the surround as it relates to the nominal thickness of the suspension portion of the surround.

In one embodiment, the triangular portion 52 of the vertical attach mount structure 12 defines a right triangle. Accordingly, the triangular portion includes interior angles of 90° and anywhere from 30° to 60° such that this structure does not inhibit nor interfere with potential downward or inward motion of the cone and coil assembly. Notably, the triangular portion defines an angled surface sloping toward the interior of the frame 20 which consequently functions to maximize the surface area of the diaphragm 27.

Accordingly, the vertical mount 14 defines structure particularly suited for forming a secure connection with a trough or channel 60 formed in the frame 20. Inner and outer parallel walls of the trough 60 can be of equal or different dimensions (See FIG. 4). The surround 24 can be attached to the frame 20 by any conventional means such as by gluing. Moreover, it is to be recognized that the particular configuration of the vertical mount 14 positions the periphery of the surround as far laterally as possible without effecting the overall width of the frame.

With reference now to FIGS. 5 and 6, aspects of the disclosed mounting structure are compared with traditional approaches. In particular, FIG. 6 depicts a conventionally mounted surround 80 connected to a frame 82. This arrangement provides less bondable surface area than the presently disclosed approach, resulting in a lower bond strength between the surround 80 and the frame 82. Pull forces applied to the conventional surround 80 from the motion of the surround can only be absorbed in one direction, i.e., perpendicular to the surround-to-frame connection. In contrast, as shown in FIG. 5, pull forces on the surround arrangement including the vertical mount 12 can be accommodated in multiple directions such as those represented by arrows 90. A pull strength advantage, therefore, is provided from the greater contact area defined by the vertical mount 12 approach.

As shown in FIG. 5, it is to be further recognized that the channel 60 can include a reservoir 92 for accepting bonding material used to connect the frame. This reservoir can be located in other walls defining the channel or wall.

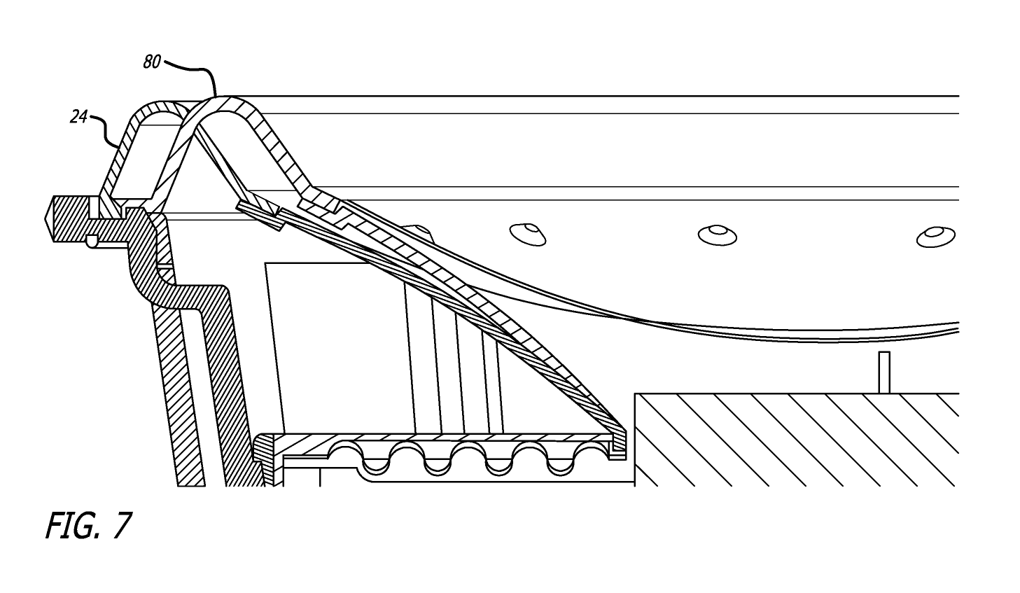

Turning now to FIG. 7, various distinctive features of the disclosed mounting arrangement are presented. One significant difference between a system including a diaphragm 24 with the vertical mount structure is that for a given speaker size, there is a larger effective cone or diaphragm area than approaches involving conventional surrounds 80. In one example, the radius of the diaphragm 24 with vertical mount structures can be 133.11 mm whereas the radius of the conventional surround is 120.82 mm. This of course desirably translates into a greater volume displaced by the presently contemplated system which in turn optimizes speaker performance. Further, in the example considered, the surround with vertical mount structure has an associated cross-sectional perimeter of 11.87 mm compared to a 9.526 mm perimeter of the conventional approach, which translates to a 24.6% gain. Further, the exemplar surround with vertical mount structure has a total connection surface area of 10,361 mm² compared to a 8,208 mm² total connection surface area of the conventional approach, or an approximate 26.23% gain. As such, an improved connection is expected by the disclosed mounting approach.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims. In that regard, various features from certain of the disclosed embodiments can be incorporated into other of the disclosed embodiments to provide desired structure.

We claim:

1. A loudspeaker system, comprising:
a frame, the frame including a channel; and
a surround including a periphery defining a vertical attach mount structure, the vertical attach mount structure sized to be received within the recess;
wherein the vertical attach mount structure includes a first rectangular portion continuous with a second triangular portion.

2. The system of claim 1, wherein the surround has a first thickness and the vertical attach mount structure has a second thickness greater than the first thickness.

3. The system of claim 1, wherein the surround includes an interior portion and the vertical mount structure extends toward the interior portion.

4. The system of claim 1, wherein the channel includes inner and outer parallel walls of different overall dimensions.

5. The system of claim 4, wherein the vertical mount has a first wall having a dimension approximating the inner wall and a second wall having a dimension approximating the outer wall.

6. The system of claim 1, wherein the channel includes a reservoir.

7. The system of claim 1, wherein the surround is formed from one or more of thermoplastic elastomers or rubber compounds.

8. The system of claim 1, further comprising a spider assembly.

9. The system of claim 8, further comprising a diaphragm, the diaphragm being mounted between the spider assembly and the surround.

10. The system of claim 9, wherein there is a three-wall connection between the surround and the diaphragm.
